(19) United States
(12) Patent Application Publication
(10) Pub. No.: US 2007/0081653 A1
(43) Pub. Date: Apr. 12, 2007

(54) Method and system for diverting telecommunications connections

(75) Inventors: Sigrid Hertelt, Munchen (DE); Udo Klotz, Neuried (DE); Bernhard Krembs, Gruenwald (DE); Irena Romanski, Egling (DE); Karl Schurr, Alling (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 11/015,642

(22) Filed: Dec. 20, 2004

(30) Foreign Application Priority Data
Aug. 28, 2000 (WO) PCT/DE00/02939
Aug. 30, 1999 (DE) 19941152.2

(51) Int. Cl. H04M 15/06; H04M 3/42; H04M 1/56

(52) U.S. Cl. 379/211.01; 379/142.12

(57) ABSTRACT

In the case of a method for diverting telecommunications connections, a prescribed number of line identifications (A1₁-A1_{N}) are first made available. Upon request to participate in the diverting method, a line identification (A1₁-A1_{N}) that is still free is allocated, all telecommunications connections directed to this line identification (A1₁) subsequently being diverted to a telecommunications terminal (A2).

The present invention relates to a method and a system for diverting telecommunications connections.

Providers of public telecommunications networks also offer a range of supplementary services in addition to the usual basic services—which are, as a rule, the setting up of telecommunications connections and the transmission of useful data for the communication. The present invention makes use of the service of call deflection that permits a user under various conditions to divert incoming connections to other terminals, for example to automatic spoken announcements, to an operator or to another terminal at which the user can temporarily be reached.

“Teleworkers”, for example, also avail themselves of such call deflection. These are to be understood to include staff members of a company who, in addition to their company workstation, also work from home from time to time and are, in particular, to be contactable there by phone. An insurance agent is an example of such a teleworker. If the latter activates the call deflection, telephone calls arriving at his company workstation are deflected automatically to his home terminal.

However, insurance agents in particular carry out the majority or even their entire work from home (possibly also only on specific days of the week), and so they use their actual company terminal only seldom or never. Maintaining a plurality of such terminals that are, in addition, only seldom used constitutes, however, a cost factor not to be neglected.

It is therefore an object of the invention to specify a method for diverting telecommunications connections that permits a flexible participation of a large number of persons and in the case of which the available telecommunications terminals and lines are used effectively.

The object is achieved by means of a method that has the features of claim 1. According to the invention, a specific quantity of line identifications that are provided for the diverting method are made available initially in this case. During the initiation of the call deflection to a terminal (for example to the home terminal of a teleworker), an as yet unoccupied line identification of the line identifications made available is then allocated. It is possible in this way to avoid communications terminals that are used only insufficiently in a company, since the use of a single line identification by a plurality of persons (only one person a specific instant in each case, of course) (sharing) is permitted. Since the setting up of telecommunications connections is performed under computer control in the switching offices, the method is easy to accomplish by supplementing the control software.

Developments of the invention are the subject matter of the subclaims. The information required for the method (which line identifications are available and are not yet occupied, to which second terminal should a telecommunications connection directed to an allocated line identifications be diverted) is preferably stored it the public switching office belonging-to these line identifications (a plurality of switching offices also being possible). After the allocation of a line identification, the diversion of the telecommunications connection is then performed automatically in this public switching office. In relation to these line identifications, there is no need at all in this case for the existence of real terminal connections or even terminal equipment (telephones or fax machines).

It would also be conceivable, for example, to use line identifications of “virtual terminal connections” such that a connection is successfully set up only when such a virtual terminal connection is assigned a real second terminal connection to which the connection is diverted. However, if corresponding terminal equipment also actually exists in relation to the line identifications, then this equipment can also be used as normal company terminals when not occupied.

The line identifications available are preferably main lines such that the management of the method according to the invention can be performed exclusively in the public switching offices. However, if the teleworker is employed in a relatively large company, it is normal there for the line identifications or the corresponding terminals at the company workstations to be combined in a private branch exchange (PBX). A portion of the branch exchange lines can then be reserved for call deflection. However, the data required for the deflection continue to be stored in the public switching office of the private branch exchange, since a diversion can then already be performed there, and a diverted telecommunications connection does not impose a load on the lines between the switching office and the private branch exchange. However, in order to ensure that a connection from another internal terminal of the branch exchange is also correctly diverted to a home terminal, the private branch exchange stores at least the information as to whether a line identification is allocated in the course of the diverting method. If this is the case, calls internal to the branch exchange are automatically forwarded to the public switching office and deflected from there to the home terminal. Furthermore, an exchange of information between the public switching office and the private branch exchange is required to integrate branch exchange terminals in the method according to the invention.

It has been possible for approximately 15 years for example in the case of ISDN connections but also of analog connections, to find out the calling number of an interlocutor. In the case of ISDN connections, there are transmitted for this purpose in the D-channel, in parallel with the useful data in the B-channel that are used for the communication, information data that reproduce a line identification and are evaluated and displayed by an appropriately designed telecommunications apparatus. Consequently, if while at work the teleworker calls a customer from his house, it will be possible for the latter to find out the private number of the teleworker. The customer would then be able to call the teleworker at home even in periods when the latter is not even working, and could disturb the latter in his leisure time.

Consequently, when a telecommunications connection is being set up from the second telecommunications terminal (that is to say, for example, from the home terminal of the teleworker) to a third telecommunications terminal (for example the telecommunications terminal of a customer), the information data containing the line identification data are modified in such a way that instead of the line identification of the second telecommunications terminal they produce the first line identification obtained at the initiation (which then corresponds to the line identification of a company terminal). Consequently, it is fundamentally only a company number, and not the private number, that is displayed during business telephone calls in the case of the method according to the invention. From the point of view of the customer, the latter therefore calls his insurance representative at the latter's company workstation and/or is called up from the representative's company workstation. It is possible to ensure in this way in conformity with labor law that the teleworker cannot be disturbed during his leisure time, since business telephone calls are deflected to him at home only when he has requested the call deflection. The data required for this purpose (first line identification and home terminal) are stored in the public switching office of the home terminal and when a connection is being set up the information data are also already modified there. Since it is impossible to rule out that different company line identifications can be allocated in each case for a teleworker when there is a repeated request for call deflection, it can be provided that the information data containing the line identification data are modified in such a way that they reproduce only a general company identification (for example, the identification of the private branch exchange).

It is also possible to provide in the case of the use of branch exchange terminals that the control software of the public switching office of the home terminal recognizes the call number internal to the branch exchange and automatically sets up a connection to the private branch exchange, the information data being modified once. As a result of this, it is not apparent even for a telecommunications terminal inside the private branch exchange whether the teleworker is located at a company workstation or at his home workstation.

In accordance with an advantageous development, the call deflection can be activated in a simple way from the home workstation, specifically by setting up a telecommunications connection to the public switching office of the line identifications made available, and transmitting a suitable control signal, for example by inputting a special code and/or a PIN number. A line identification that is still free is then automatically allocated. However, it would also be conceivable specifically to request one of the line identifications and/or also to deal preferably with persons with a higher entitlement status, that is to say, if appropriate, to transmit an already allocated line identification to the newly requesting, but more highly entitled teleworker. The corresponding information is then also transmitted simultaneously to the public switching office of the home terminal. If the company workstation is a component of a private branch exchange, it can be provided that a corresponding control signal is also transmitted to the private branch exchange.

It is frequently desired for the possibility of conducting private conversations from the home terminal still to exist even after the activation of the call deflection. It can therefore be provided that the modification of the information data can be suppressed for this call by dialing a specific code that is recognized by the public switching office of the home workstation. It is thereby possible to distinguish very easily in the public switching office of the home terminal whether a business or a private conversation is in the process of being conducted so that separate bills can be prepared.

It may also be desired for the option to be given to request call deflection from an arbitrary external terminal, and that the first line identification and the second terminal, to which the telecommunications connections are to be diverted, are not established until the request. This then permits, for example, telephone calls to be deflected to an arbitrary terminal at which a person can be reached temporarily (for example, to a hotel terminal during a business trip). There is also the option of diverting the connections to a cell phone.

In accordance with a further aspect of the invention, the independent claim 11 proposes a system with the aid of which such a diverting method can be carried out. The essential components of the system are a plurality of provided line identifications that are managed by a switching office connected to them. This switching office then includes means for storing the required information that says whether and to which telecommunications terminal a telecommunications connection directed to one of the provided line identifications is to be diverted. Also provided in the switching office are the means required for diverting telecommunications connections such that said means carry out the diversion automatically if necessary.

The invention is to be explained in more detail below with the aid of the attached drawing, in which

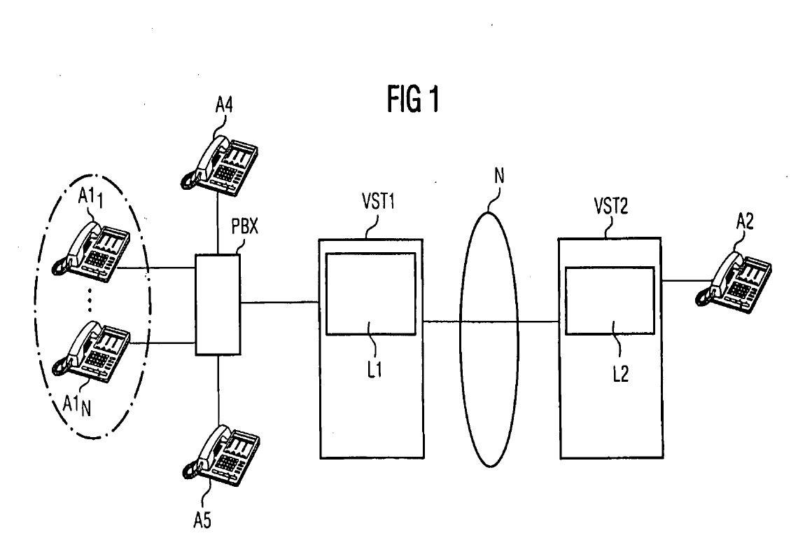

FIG. 1 shows a diagram of the telecommunications terminals and switching offices participating in the method according to the invention;

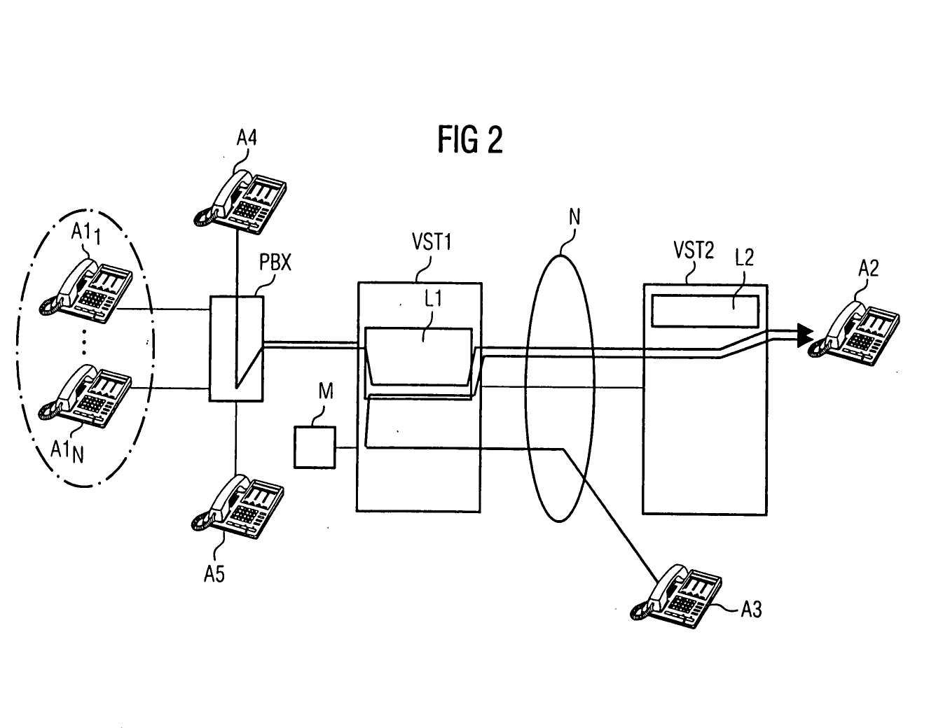

FIG. 2 shows the diversion of telecommunications connections directed to a company line identification to the home workstation;

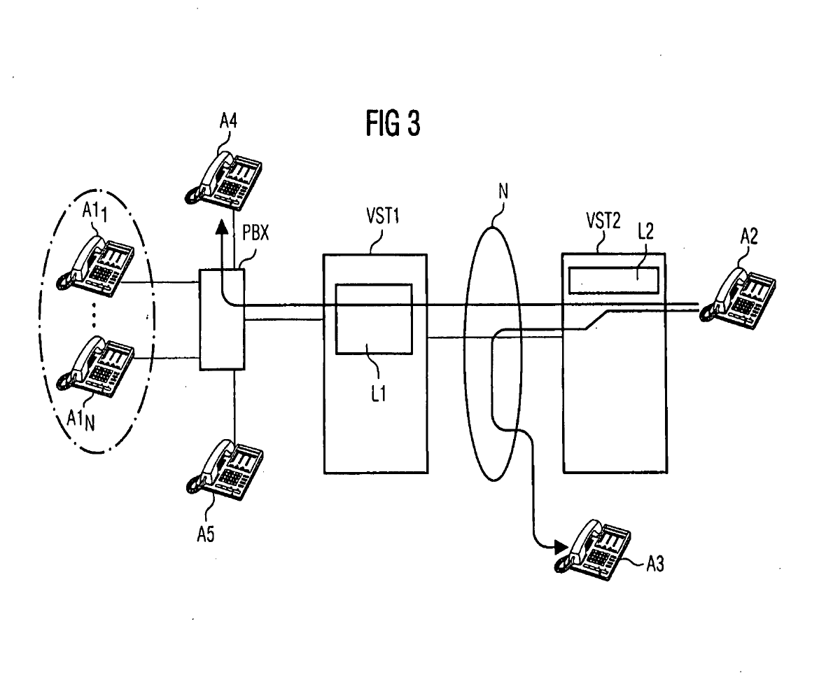

FIG. 3 shows the design of telecommunications connections from the home workstation; and

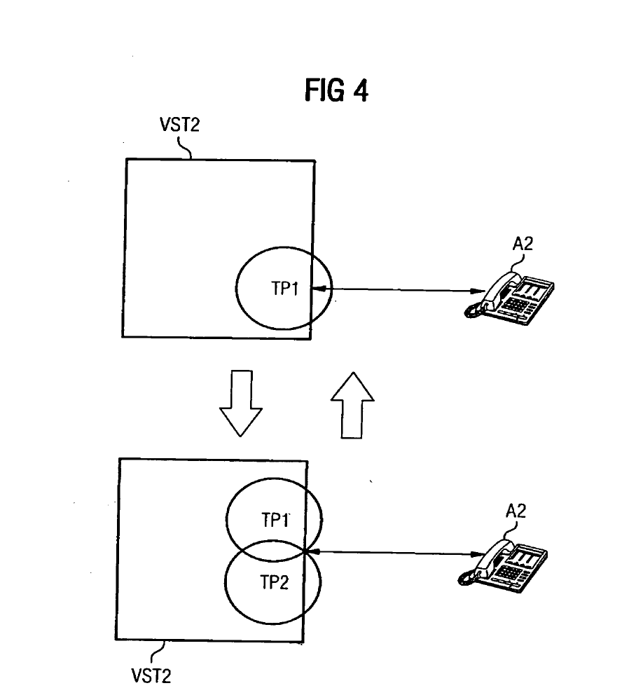

FIG. 4 shows the response of the home terminal in the case of private and of business telephone calls.

The method according to the invention is preferably implemented by means of Centrex (Central Office Exchange Service). This is a service packet in the public network that provides means for constructing a corporate network with branch exchange functions. Centrex provides the possibility of combining the first line identification A1₁ obtained when making a request with the second telecommunications terminal A2, that is to say with the home terminal, logically in a network-wide “Centrex group”.

In the example illustrated in FIG. 1, all the line identifications of the company are a component of a private branch exchange PBX. Of these line identifications, the identifications A1₁ to A1_{N} are provided for the diverting method, and the two other terminals A4, A5 are used, by contrast, only for company workstations. As already mentioned, no real terminals need necessarily exist in relation to the identifications A1₁ to A1_{N} provided for the diverting method, they can just as well be “virtual”—at least in the case of a part thereof. The connection of this private branch exchange PBX to the telecommunications network N is performed via the public switching office VST1 of the private branch exchange PBX. This public switching office VST1 includes a storage device, denoted below as teleworker list L1, that permits rapid access to the data of the line identifications A1₁ to A1_{N}. For each individual line identification, these data comprise at least the information as to whether this has already been allocated and to which terminal a connection is to be forwarded. Furthermore, it would also be possible to store a list of the persons that are authorized to participate in the diverting method, together with their access codes.

If one of the line identifications A1₁ to A1_{N} is allocated, the associated information is also stored in a second teleworker list L2 that is a component of the public switching office VST2 of the corresponding home terminal A2.

A call deflection is activated by the teleworker inputting the prescribed access code from his home terminal A2 and subsequently inputting a personal PIN number for his identification. This is recognized by the switching office VST1 of the private branch exchange PBX, and a free line identification (the line identification A1₁ in the present example), is assigned to the home terminal A2, and the information is forwarded to the switching office VST2 of the home terminal A2. The call deflection can also be deactivated again in the same way. There is then the possibility, for example, of detecting the times of logging on and off, and thus also the working time of the teleworker. As already mentioned at the beginning, it can also be provided that some persons are preferably dealt with when requesting the diverting method, and carry out “prioritize login”(for example by inputting a special code). It can then be established that these persons are allocated a line identification in any case, it being possible in the extreme case to allocate an already occupied identification for this purpose.

FIG. 2 shows the diversion according to the invention of telecommunications connections directed to the line identification A1₁. If, for example, a customer dials the number of the line identification A1₁ on his external terminal A3, the connection is firstly set up as far as the public switching office VST1 of the private branch exchange PBX. On the basis of the information stored in the teleworker list L1, however, it is recognized in the public switching office VST1 that the call is to be deflected to the telecommunications terminal A2. The telecommunications connection is then diverted directly from there such that the lines between the public switching office VST1 and the private branch exchange PBX of the company are not loaded. Furthermore, this diversion is not visible to the telecommunications terminal A3, and so from his point of view the customer is calling the teleworker at a company workstation A1_{1.}

If the line identification A11 is called from the terminal A4, which is likewise integrated in the private branch exchange PBX, it is normally sufficient in private branch exchanges to dial only an abbreviated direct dial number. Consequently, in order to permit a diversion to the home terminal A2 here, as well, at least the information as to whether a connection directed to the line identification A1₁ is to be diverted or not is stored in the private branch exchange PBX. When a request is made for call deflection, the corresponding information can be transmitted from the switching office VST1 to the private branch exchange PBX by means of QSIG (Q-(Reference Point) Signaling). If a deflection is desired, the connection is simply forwarded to the public switching office. Once again, a telecommunications connection directed to the line identification A1₁ is then recognized in the public switching office VST1 and is then diverted to the home terminal A2 in accordance with the stored information in the teleworker list L1. Here, as well, the deflection is not visible to the caller. Moreover, there also continues to be the possibility, of course, of reaching the teleworker at his home workstation A2 through his usual private number.

It can be provided for the case of a diverted telecommunications connection that the calling subscriber is subject to charges only for setting up the connection as far as the public switching office VST1, whereas the remainder of the communications link is charged to the teleworker (or the company thereof). It would also be conceivable to select from the terminal A3 a line identification—for example, the identification A1_{N}—that is a “virtual” terminal which is, however, not even allocated at this instant. In this case, this connection can be forwarded to a mailbox M, to a general company terminal or to the central terminal of the private branch exchange PBX.

FIG. 3 illustrates the setting up of telecommunications connections originating from the home terminal A2 of the teleworker. If the latter dials the number of the terminal A3 (for example of a customer), the telecommunications connection is set up in a known way via the public switching office VST2 of the home terminal A2 and the telecommunications network N to the external terminal A3. In addition, however, on the basis of the information stored in the teleworker list L2 of the public switching office VST2, the information data transmitted in parallel is now modified. If the customer at the terminal A3 is capable of identifying the interlocater on the basis of the information data, it is not the number of the home terminal A2, but the number of the line identification A1₁ obtained when the request was made that appears in his display. From the point of view of the terminal A3, it is the company terminal with the identification A1₁ that is the origin of the telecommunications connection. This prevents the customer from finding out the private number of the teleworker and possibly calling up the latter during his leisure time. Since, however, a teleworker can be allocated various line identifications in the case of repeated requests, it can be established alternatively that the modified information data display only the general number of the private branch exchange PBX or a central company number but not the concrete identification A1₁.

If the teleworker would like to call from his home terminal A2 to a colleague at the latter's company workstation A4, it is also sufficient at his home terminal A2 to dial only the direct call number internal to the branch exchange. This is recognized by the public switching office VST2, and the telecommunications connection is forwarded automatically via the public switching office VST1 to the private branch exchange PBX, and from there to the extension A4.

If the line identifications are made available inside a private branch exchange, it is necessary for exchange of data and information to be possible between the private branch exchange and the public switching office if the call deflection is to be performed as early as there. Consequently, the line identifications A1₁ to A1_{N} made available are preferably respectively main lines that can be managed entirely by the public switching office.

It can be provided for the teleworker also to be able to conduct private conversations from his home terminal A2 even after requesting call deflection. In this case, he firstly dials a special control code in order to suppress the modification of the information data temporarily for a call, and subsequently dials the desired call number. The private number of the terminal A2 and not the line identification A1₁ then appears at the called terminal.

The response of the home terminal A2 and of the public switching office VST2 are illustrated once again schematically in FIG. 4. If the call deflection is not activated (up), the terminal A2 responds like a normal private telephone connection with the private subscriber profile TP1. This subscriber profile TP1 reports, for example, under which call number the terminal A2 can be reached, and whether the latter is availing itself of any sorts of additional services (call waiting, mailbox etc).

If the teleworker logs on for call deflection, the terminal A2 additionally receives the teleworker profile TP2. How the terminal A2 then actually responds depends on the incoming and outgoing telecommunications connections. If the connection that is directed to the line identification Al: but is diverted arrives at the terminal A2, or if the teleworker dials a number after logging on for call deflection, the terminal A2 responds in accordance with the teleworker profile TP2 like the company line identification A1₁. In the case of incoming connections that come about through dialing of the private number or through inputting of the previously mentioned control code, the terminal A2 responds, however, like the usual residence telephone in accordance with the normal subscriber profile TP1.

In accordance with a first embodiment, the teleworkers are entitled to participate in the diverting method only from their home terminal A2. In this case, the identifications of the authorized home terminals can already be stored in the public switching office VST1 of the private branch exchange. However, it can be provided for reasons of flexibility that also the second terminal to which a telecommunications connection is to be diverted, is not determined until a request is being made. This can be performed, for example, by the teleworker dialing from the terminal to which the connections are to be diverted a special control code for activating the call deflection, subsequently dialing the number of the desired second terminal (which could also, however, possibly be recognized automatically), and dialing a personal PIN number for his identification. Then, for example, only the information as to which persons are entitled to avail themselves of the diverting service would initially be stored in the teleworker list L1. Only during logon can the information then be supplemented and a new entry be made to the switching office of the second terminal. It is therefore possible to switch into the system from an arbitrary public terminal.

Furthermore, it would then also be possible to deflect the calls to a cell phone (for example a GSM phone).

Since the method according to the invention can be realized merely by supplementing the switching office technology, independence from the locations of the terminals is achieved. A change in location requires only a new entry in the teleworker lists, that is to say only a low administrative outlay.

1. A method for diverting telecommunications connections for line identifications of a private branch exchange in a public switching office in a information is stored to a telecommunications terminal with reference to the diverted telecommunications connections directed to one of the line identifications, comprising:
providing a prescribed number of line identifications; and
requesting from a telecommunications terminal, participation in the diverting with the allocation of one of the line identifications, wherein the diverting
of a telecommunications connection directed to an allocated line identification to the telecommunications terminal is performed in the public switching office.

2. The method as claimed in claim 1, wherein the allocated line identification and the identification of the telecommunications terminal are stored in a public switching office of the telecommnunications terminal,
transmitted in parallel an information signal that includes data to reproduce a line identification, and
the information signal is modified when setting up a telecommunications connection from the telecommunications terminal to another telecommunications terminal.

3. The method as claimed in claim 2, wherein the information signal is modified such that it reproduces the line identification allocated in the course of the diversion.

4. The method as claimed in claim 3, wherein the information signal is modified such that it reproduces the line identification of the private branch exchange.

5. The method as claimed in claim 2, wherein the modification of the information data can be switched off temporarily by inputting a special control signal.

6. The method as claimed in claim 1, wherein the diversion is initiated from the telecommunications terminal by inputting a prescribed access code.

7. The method as claimed in claim 1, wherein the telecommunications terminals participating in the diverting are prescribed, and the identifications are stored in the public switching offices of the provided line identifications and/or the private branch exchange.

8. The method as claimed in claim 1, wherein a request is made by transmitting a control signal from an arbitrary terminal to which the telecommunications connections are diverted.

9. A system for diverting telecommunications connections, comprising:
a public switching office having a device to store information with reference to a diversion of telecommunications connections directed to one of a plurality of provided line identifications to a telecommunications terminal and to divert telecommunications connections; and
a private branch exchange connected to a plurality of line identifications and to manage the provided line identifications, wherein
the telecommunications connections that are directed to the line identification of the private branch exchange allocated during the request are diverted automatically toward the switching office to the telecommunications terminal.

10. The system as claimed in claim 9, further comprising a second switching office connected to the second telecommunications terminal, the second switching office including a device to store the line identification of another telecommunications terminal to which it is diverted, and the line identification is allocated to the second telecommunications terminal modifies information data to reproduce a line identification.
